(19) United States
(12) Patent Application Publication
(10) Pub. No.: US 2025/0006913 A1
(43) Pub. Date: Jan. 2, 2025

(54) POSITIVE ELECTRODE ACTIVE MATERIAL FOR LITHIUM SECONDARY BATTERY, POSITIVE ELECTRODE FOR LITHIUM SECONDARY BATTERY, AND LITHIUM SECONDARY BATTERY

(71) Applicant: SUMITOMO CHEMICAL COMPANY, LIMITED, Tokyo (JP)

(72) Inventor: Shingo TACHIBANA, Niihama-shi (JP)

(73) Assignee: SUMITOMO CHEMICAL COMPANY, LIMITED, Tokyo (JP)

(21) Appl. No.: 18/293,670

(22) PCT Filed: Jul. 27, 2022
(86) PCT No.: PCT/JP2022/028930

§ 371 Date: Jan. 30, 2024

(30) Foreign Application Priority Data
Aug. 3, 2021 (JP) 2021-127566

(51) Int. Cl. H01M 4/525; C01G 53/00; H01M 4/02; H01M 10/052

(52) U.S. Cl. CPC H01M 4/525; C01G 53/42; H01M 10/052; C01P 2006/12; C01P 2006/40; H01M 2004/021; H01M 2004/028

(57) ABSTRACT

A positive electrode active material for a lithium secondary battery, containing a lithium metal composite oxide and an Li—X compound containing Li and an element X, in which the Li—X compound is a lithium-ion conductive oxide, the lithium metal composite oxide contains secondary particles, which are aggregates of primary particles, the secondary particles have gaps among the primary particles, the Li—X compound is present at least in the gap, the element X is one or more elements selected from the group consisting of Nb, W, and Mo, and the positive electrode active material for the lithium secondary battery satisfies (A).

4.95≤L_{A}/Lₐᵥ (A)

### CROSS-REFERENCE TO RELATED APPLICATIONS

The present application claims priority under 35 U.S.C. § 371 to International Patent Application No. PCT/JP2022/028930, filed Jul. 27, 2022, which claims priority to and the benefit of Japanese Patent Application No. 2021-127566, filed Aug. 3, 2021. The contents of these applications are hereby incorporated by reference in their entireties.

### TECHNICAL FIELD

The present invention relates to a positive electrode active material for a lithium secondary battery, a positive electrode for a lithium secondary battery, and a lithium secondary battery.

### BACKGROUND ART

A positive electrode active material for a lithium secondary battery is used for a positive electrode configuring a lithium secondary battery. The positive electrode active material for the lithium secondary battery contains a lithium metal composite oxide.

As a technique for improving battery characteristics of a lithium secondary battery, for example, Patent Literature 1 discloses a method for producing a positive electrode active material including a step of mixing a nickel-containing hydroxide, a lithium compound, and a niobium compound to obtain a lithium mixture.

Additionally, Patent Literature 2 discloses a positive electrode active material containing a lithium metal composite oxide and a compound containing lithium and niobium. Patent Literature 2 discloses that the surface of primary particles of the lithium metal composite oxide is covered with the compound containing lithium and niobium.

### CITATION LIST

### Patent Literature

[Patent Literature 1] JP-A-2015-122298
[Patent Literature 2] JP-A-2020-53383

### SUMMARY OF INVENTION

### Technical Problem

Patent Literatures 1 and 2 disclose that the addition of niobium to the positive electrode active material improves battery characteristics.

On the other hand, when a lithium metal composite oxide and a compound containing niobium, tungsten, or molybdenum are mixed and calcined, sintering of primary particles and crystal growth are likely to be hindered. When the sintering at calcination and the crystal growth are hindered, the average crystallite diameter of positive electrode active material particles is likely to be small. As a result, the lithium secondary battery using the produced positive electrode active material pose a problem of likely reducing an initial discharge capacity, an initial efficiency, and a cycle characteristic.

The present invention was made in view of the above circumstance and has an object to provide a positive electrode active material for a lithium secondary battery, a positive electrode for a lithium secondary battery, and a lithium secondary battery with excellent initial discharge capacity, initial efficiency, and cycle characteristic even when a compound containing niobium, tungsten, or molybdenum is added.

### Solution to Problem

The present invention includes [1] to [10].

[1] A positive electrode active material for a lithium secondary battery, containing a lithium metal composite oxide and an Li—X compound containing Li and an element X, in which the Li—X compound is a lithium-ion conductive oxide, the lithium metal composite oxide contains secondary particles, which are aggregates of primary particles, the secondary particles have gaps among the primary particles, the Li—X compound is present at least in the gap, the element X is one or more elements selected from the group consisting of Nb, W, and Mo, and the positive electrode active material for the lithium secondary battery satisfies (A).

4.95≤L_{A}/Lₐᵥ (A)

(In (A), L_{A} is a crystallite diameter calculated from the highest diffraction peak within a range of 2θ=18.5±1° in a diffraction pattern of powder X-ray diffraction of the positive electrode active material for the lithium secondary battery measured using a CuKα ray, and Lₐᵥ is an average crystallite diameter calculated from diffraction patterns included within a range of 2θ of 10° or more and 90° or less in the diffraction pattern.)

[2] The positive electrode active material for the lithium secondary battery according to [1], in which D₅₀, a 50% cumulative volume particle diameter of the positive electrode active material for the lithium secondary battery, is 3 μm or more and 20 μm or less.

[3] The positive electrode active material for the lithium secondary battery according to [1] or [2], in which a BET specific surface area of the positive electrode active material for the lithium secondary battery is 0.2 m²/g or more and 2.5 m²/g or less.

[4] The positive electrode active material for the lithium secondary battery according to any one of [1] to [3], represented by a composition formula (I).

Li[Liₐ(Ni_{(1-y-z-w)}Co_{y}M_{z}X_{w})₁₋ₐ]O₂ (I)

(In the composition formula (I), M is one or more elements selected from the group consisting of Mn, Fe, Cu, Ti, Mg, Al, Zn, Sn, Zr, Ga, B, Si, S, and P, X is one or more elements selected from the group consisting of Nb, W, and Mo, and the composition formula (I) satisfies −0.1≤a≤0.2, 0≤y≤0.5, 0<z≤0.7, 0<w≤0.1, and y+z+w<1.)

[5] The positive electrode active material for the lithium secondary battery according to any one of [1] to [4], in which D₁₀, D₉₀, and D₅₀ satisfy (B).

(D₉₀−D₅₀)/(D₅₀−D₁₀)≤2.0 (B)

(In (B), D₁₀ is a 10% cumulative volume particle diameter of the positive electrode active material for the lithium secondary battery, D₅₀ is a 50% cumulative volume particle diameter of the positive electrode active material for the lithium secondary battery, and D₉₀ is a 90% cumulative volume particle diameter of the positive electrode active material for the lithium secondary battery.)

[6] The positive electrode active material for the lithium secondary battery according to any one of [1] to [5], in which Lₐᵥ is 80 Å or more and 150 Å or less.

[7] The positive electrode active material for the lithium secondary battery according to any one of [1] to [6], in which Lₐ is 500 Å or more and 700 Å or less.

[8] The positive electrode active material for the lithium secondary battery according to [3], in which the BET specific surface area is 1.5 m²/g or more.

[9] A positive electrode for a lithium secondary battery, containing: the positive electrode active material for the lithium secondary battery according to any one of [1] to [8].

[10] A lithium secondary battery, having the positive electrode for the lithium secondary battery according to [9].

### Advantageous Effects of Invention

The present invention can accordingly provide a positive electrode active material for a lithium secondary battery, a positive electrode for a lithium secondary battery, and a lithium secondary battery with excellent initial discharge capacity, initial efficiency, and cycle characteristic even when a compound containing niobium, tungsten, or molybdenum is added.

### BRIEF DESCRIPTION OF DRAWINGS

FIGS. 1(a) and 1(b) are schematic views to illustrate the crystallite diameter in the present invention.

FIG. 2 is a schematic configuration diagram showing an example of a lithium secondary battery.

FIG. 3 is a schematic view showing an entire configuration of an all-solid-state lithium secondary battery.

### DESCRIPTION OF EMBODIMENTS

In the present description, the metal composite compound is hereinafter referred as “MCC”. The lithium metal composite oxide is hereinafter referred as “LiMO”.

A positive electrode active material for a lithium secondary battery is hereinafter referred as “CAM” as an abbreviation for a cathode active material for a lithium secondary battery.

The writing “Li” shows the Li element, but not Li metal as a simple substance, unless otherwise specified. The writings for other elements such as Ni, Co, and Mn are also the same.

In a case where a numerical range is expressed as, for example, “1 to 10 μm”, this means a numerical value range from 1 μm to 10 μm, including the lower limit value (1 μm) and the upper limit value (10 μm), that is, “1 μm or more and 10 μm or less”.

### <Positive Electrode Active Material for Lithium Secondary Battery>

CAM of the present embodiment includes LiMO and an Li—X compound containing Li and an element X. The positive electrode active material for the lithium secondary battery satisfies (A) to be described later.

CAM and LiMO are particles, and the particles include the primary particle, and the secondary particle.

In the present description, the “primary particle” is a particle whose appearance has no grain boundary, and means particles constituting the secondary particle. More specifically, the “primary particle” means the particle on the surface of which has no clear grain boundary when observed using a scanning electron microscope or the like with 5000 to 20000 times field of view.

In the present description, the “secondary particle” means a particle in which a plurality of the primary particles are three-dimensionally bound with gaps. The secondary particle has a shape such as a spherical shape or approximately spherical shape.

Typically, the secondary particle is formed when 10 or more of the primary particles aggregate.

In the present embodiment, the secondary particle in LiMO is an aggregate of primary particles, and includes gaps among the primary particles.

In the present description, the “gap”, when described as such, means gaps formed among the primary particles constituting the secondary particle.

### <<LiMO>>

LiMO is a compound containing Li, Ni, an optional metal element Co, and an element M. The element M is one or more elements selected from the group consisting of Mn, Fe, Cu, Ti, Mg, Al, Zn, Sn, Zr, Ga, B, Si, S, and P.

### <<Li—X Compound>>

The Li—X compound is a compound containing Li and an element X, and a lithium-ion conductive oxide. The element X is one or more elements selected from the group consisting of Nb, W, and Mo. The Li—X compound is present at least in the gap among the primary particles of LiMO.

Examples of the Li—X compound specifically include lithium niobate, lithium tungstate, and lithium molybdate.

Examples of lithium niobate include Li₃NbO₄, LiNbO₃, LiNb₃O₈, and Li₈Nb₂O₉ and the like. Lithium niobate has lithium-ion conductivity.

Examples of lithium tungstate include LiWO₃, Li₂WO₄, Li₄WO₅, and Li₆W₂O₉. Lithium tungstate has lithium-ion conductivity.

Examples of lithium molybdate include Li₂MoO₄, Li₄MoO₅, and Li₆Mo₂O₉. Lithium molybdate has lithium-ion conductivity.

From the viewpoint of exhibiting high lithium-ion conductivity, the Li—X compound is preferably lithium niobate or lithium tungstate, and particularly preferably lithium niobate.

### [Confirmation Method of Li—X Compound]

Whether or not the Li—X compound is present in the gap described above can be confirmed by the following method.

First, a cross section of a CAM particle is obtained by the following method.

Subsequently, using an image of the obtained cross section, scanning transmission electron microscope-energy dispersive X-ray measurement is performed.

### (Step of Obtaining Cross Section of CAM Particle)

For the method of obtaining a cross section of a CAM particle, a single particle of CAM is processed with a focused ion beam system, thereby obtaining a cross section of a single particle of CAM. For the focused ion beam system, for example, FB2200 manufactured by Hitachi High-Technologies Corporation can be used.

In addition, when a cross section of CAM in a positive electrode is obtained, a part of the positive electrode produced using CAM is cut out and processed with an ion milling system, thereby obtaining a cross section of a CAM particle contained in the electrode mixture layer.

For the particle whose cross section is obtained, it is preferable to select CAM particles showing the highest diameter of 50% cumulative volume particle diameter (D₅₀ μm)±5% obtained by laser diffraction particle size distribution measurement.

The particle is cut in such a way as to pass near the centroid of the CAM particle, and it is preferable to select and observe those whose length of the major axis of the obtained CAM particle cross section is D₅₀ (μm)±5%.

CAM to be cross-sectionally processed is preferably powder CAM, but can be CAM contained in an electrode or a CAM powder embedded in a resin.

### (Transmission Electron Microscopic Observation)

Whether or not the Li—X compound is present in the gap can be confirmed by observing the cross section of CAM obtained by the above method using a transmission electron microscope (TEM).

As TEM, JEM-2100F manufactured by JEOL Ltd. can be used.

Specifically, the cross section of a CAM particle is observed using TEM, and elemental analysis on the cross section of the CAM particle is performed by energy dispersive X-ray spectroscopy. As the energy dispersive X-ray spectroscopy (abbreviation EDX), Centurio manufactured by JEOL Ltd. can be used.

The site at which an element X is detected by EDX is decided to be the site where the compound containing the element X is present.

Whether or not the compound containing the element X is the Li—X compound containing Li can be confirmed by X-ray absorption fine structure (XAFS) analysis, X-ray photoelectron spectroscopy (XPS) analysis and the like.

According to the XAFS analysis, the information on local structure of the focused atom can be obtained. Examples of the local structure of an atom include atomic valence, adjacent atomic species, bonding properties, and the like.

In the XAFS analysis, the ratio of an X-ray intensity (I₀) before irradiating a subject to be measured to an X-ray intensity (I) after transmitted through the subject to be measured is measured and analyzed.

In the XPS analysis, the sample surface is irradiated with X-ray and a generated photoelectron energy is measured, thereby analyzing a constituent element of the sample and an electronic state thereof. When the XPS analysis is performed, the composition of the compound containing the element X can be analyzed.

In the present embodiment, the composition analysis of the compound containing the element X utilizes the XAFS analysis.

Specifically, the produced CAM containing the element X is introduced into a measuring device XAFS beam line, the element X is measured with XAFS and analyzed under the following conditions. At that time, a standard sample of an estimated Li—X compound is also measured with XAFS.

Measuring device: Inter-University Research Institute Corporation High Energy Accelerator Research Organization BL-12C Measuring absorption edge: Nb—K absorption edge, W-L absorption edge, Mo—K absorption edge

Concerning the obtained XAFS spectrum, a baseline value is subtracted from a peak value, and peak shapes of CAM and the standard sample are compared, thereby analyzing the composition of the compound containing the element X.

In the present description, the “central part of a particle” means, in the TEM-EDX image obtained by the above method, the area equivalent to 50% from the center side of the radius from the center to the surface of the particle.

In the present description, the “surface part of a particle” means, in the TEM-EDX image obtained by the above method, the area that covers from the outermost surface of the particle up to a depth of about 10 nm toward the center of the particle from the outermost surface.

In the present description, the “outer periphery of a particle” means, in the TEM-EDX image obtained by the above method, the area that is not applicable to the above central part of the particle or the above surface part of the particle.

CAM of the present embodiment may have, when decided from the TEM-EDX image, the Li—X compound present in the gap at the central part of the secondary particle.

CAM of the present embodiment may have, when decided from the TEM-EDX image, the Li—X compound present in the gap at the outer periphery of the secondary particle.

CAM of the present embodiment may have, when decided from the TEM-EDX image, the Li—X compound present in the gap at the central part of the secondary particle and in the gap at the outer periphery of the secondary particle.

CAM of the present embodiment may have, when decided from the TEM-EDX image, the Li—X compound present in the gaps present throughout the entire area from the central part of the secondary particle to the surface part of the secondary particle.

CAM of the present embodiment may have, when decided from the TEM-EDX image, the Li—X compound present on the surface part of the secondary particle. However, an aspect in which the Li—X compound is present only on the surface part of the secondary particle is not included.

The Li—X compound present in the gap of CAM acts as a lithium-ion conductive layer. For this reason, CAM of the present embodiment easily diffuses lithium ions, thereby likely reducing the resistance at the time of insertion and desorption of lithium ions. Thus, the initial discharge capacity and initial efficiency of a lithium secondary battery can be improved.

CAM of the present embodiment satisfies (A) below.

4.95≤L_{A}/Lₐᵥ (A)

(In (A), L_{A} is a crystallite diameter calculated from the highest diffraction peak within a range of 2θ=18.5±1° in a diffraction pattern of powder X-ray diffraction of CAM measured using a CuKα ray.)

Lₐᵥ is an average crystallite diameter calculated from diffraction patterns included within a range of 2θ of 10° to 90° in the diffraction pattern.)

### [Measurement Method of L_{A}]

L_{A} can be obtained by the following method.

Powder X-ray diffraction measurement is performed using CuKα as a radiation source in a measurement range of diffraction angle 2θ being 10° to 90°, to obtain diffraction patterns. From the obtained diffraction patterns, the highest diffraction peak in the range of 2θ=18.5±1° is determined.

For the powder X-ray diffraction measurement, an X-ray diffractometer, for example, D8 Advance manufactured by Bruker Corporation, can be used.

Measurement conditions are described below.

### (Measurement Conditions)

Sampling width: 0.02
Scan speed: 4°/min

A half width of the determined diffraction peak is calculated, and a crystallite diameter (L_{A}) is calculated using Scherrer equation L=Kλ/Bcosθ (L: crystallite diameter, K: Scherrer constant, B: peak half width).

The calculation of a crystallite diameter using the Scherrer equation is a technique that has been conventionally used. For example, “X-Sen Kozokaiseki—Genshi no hairetsu wo kimeru—(in Japanese), X-Ray structural analysis—Determination on atomic arrangement—”, 3^{rd} ed, published on Apr. 30, 2002, written by Yoshio Waseda, Eiichiro Matsubara can be referred.

Hereinbelow, CAM will be more specifically described in reference to drawings, using a case where CAM has a hexagonal crystal structure belonging to the space group R-3m.

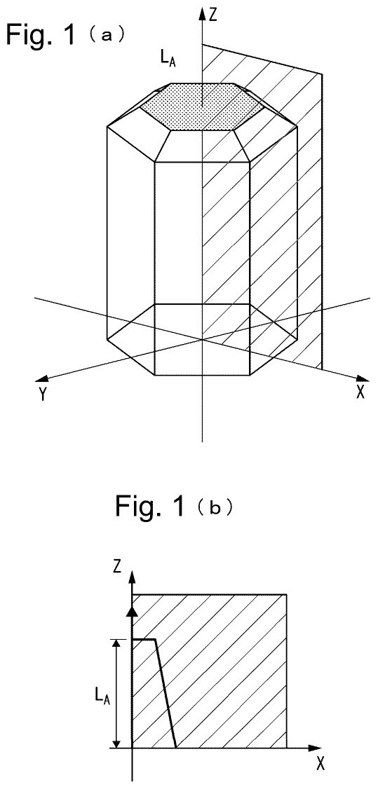

FIG. 1 (a) shows a schematic view of the 003 plane of the crystallite. In FIG. 1 (a), the crystallite diameter in a perpendicular direction of the 003 plane is equivalent to the crystallite diameter L_{A} (Å) (FIG. 1 (b)).

A large value of the crystallite diameter L_{A} means the growth of CAM particles in a layer direction. Thus, when CAM particles are growing in a layer direction, the resistance at the time of insertion and desorption of lithium ions is likely to be reduced, thereby enhancing the initial discharge capacity and initial efficiency of a lithium secondary battery.

### [Measurement Method of Lₐᵥ]

Lₐᵥ is the average crystallite diameter calculated from diffraction patterns of powder X-ray diffraction within a range of 2θ of 10° to 90° in the powder X-ray diffraction measurement using a CuKα ray.

Lₐᵥ of CAM is the crystallite diameter calculated by the Rietveld analysis on the obtained diffraction patterns. The Rietveld analysis is the method in which a crystal structure is first estimated, and parameters related to this crystal structure are refined by the least-squares method, thereby determining the crystal structure. Examples of the analysis software for the Rietveld analysis include TOPAS, Rietan, JANA, JADE, and the like.

<<L_{A}/L_{av>>}

CAM in which L_{A}/Lₐᵥ satisfies (A) means a high abundance ratio of particles grown in a layer direction, and the crystal structure involved with the insertion and desorption of lithium ions in the crystal structure is effectively developing. The lithium secondary battery using CAM having such a crystal structure has few crystal factors that become the resistance during the insertion and desorption of lithium ions, and the initial discharge capacity, initial efficiency, and cycle retention are likely to improve.

Preferable examples of (A) are described below.

4.99≤L_{A}/Lₐᵥ (A)-1

5.00≤L_{A}/Lₐᵥ (A)-2

5.05≤L_{A}/Lₐᵥ (A)-3

5.15≤L_{A}/Lₐᵥ (A)-4

5.20≤L_{A}/Lₐᵥ (A)-5

Preferable examples of (A) are further described below.

4.95≤L_{A}/Lₐᵥ≤9.9 (A)-10

4.99≤L_{A}/Lₐᵥ≤8.8 (A)-11

5.00≤L_{A}/Lₐᵥ≤7.7 (A)-12

5.05≤L_{A}/Lₐᵥ≤7.0 (A)-13

5.15≤L_{A}/Lₐᵥ≤6.5 (A)-14

5.20≤L_{A}/Lₐᵥ≤6.0 (A)-15

CAM has preferably a Lₐᵥ of 80 to 150 Å, more preferably 90 to 140 Å, and still more preferably 100 to 130 Å.

When Lₐᵥ is within the above range, the crystallite sufficiently grows, and lattice defect and distortion are rare. For this reason, the resistance at the time of insertion and desorption of lithium ions is low, and the initial discharge capacity and initial efficiency of the lithium secondary battery are likely to enhance. Furthermore, the particle cracking caused by overgrowing crystallite is suppressed, and the cycle retention of the lithium secondary battery is likely to enhance.

CAM has preferably a L_{A} of 500 to 700 Å, more preferably 510 to 690 Å, and still more preferably 520 to 680 Å.

When L_{A} is within the above range, CAM particles sufficiently grow in a layer direction, and the resistance at the time of insertion and desorption of lithium ions is low. For this reason, when L_{A} is within the above range, the initial discharge capacity and initial efficiency of the lithium secondary battery are likely to enhance.

### [D₅₀]

CAM has preferably D₅₀, the 50% cumulative volume particle diameter of CAM, of 3 to 20 μm, more preferably 5 to 18 m, and still more preferably 8 to 15 m.

When D₅₀ of CAM is within the above range, CAM can be easily filled when producing a positive electrode, and have good contact with a conductive auxiliary, thereby producing a positive electrode with low resistance. Thus, the initial efficiency and cycle retention of the lithium secondary battery are likely to enhance.

[D₁₀, D₉₀, and D₅₀]

CAM preferably has D₁₀, D₉₀, and D₅₀ satisfying the following (B).

(D₉₀−D₅₀)/(D₅₀−D₁₀)≤2.0 (B)

(In (B), D₁₀ is the 10% cumulative volume particle size of CAM, and D₉₀ is the 90% cumulative volume particle diameter of CAM.)

Preferable examples of (B) are described below.

(D₉₀−D₅₀)/(D₅₀−D₁₀)≤1.9 (B)-1

(D₉₀−D₅₀)/(D₅₀−D₁₀)≤1.8 (B)-2

(D₉₀−D₅₀)/(D₅₀−D₁₀)≤1.75 (B)-3

Preferable examples of (B) are further described below.

1.0≤(D₉₀−D₅₀)/(D₅₀−D₁₀)≤2.0 (B)-10

1.2≤(D₉₀−D₅₀)/(D₅₀−D₁₀)≤1.9 (B)-11

1.4≤(D₉₀−D₅₀)/(D₅₀−D₁₀)≤1.8 (B)-12

1.6≤(D₉₀−D₅₀)/(D₅₀−D₁₀)≤1.75 (B)-13

When CAM is in a range satisfying (B), CAM can be easily filled when producing a positive electrode, and have good contact with a conductive auxiliary to be good, thereby producing a positive electrode with low resistance. Furthermore, when CAM satisfies (B), CAM capable of sufficiently exhibiting battery characteristics can be produced, while sintering of primary particles is hindered. For this reason, the initial efficiency and cycle retention of the lithium secondary battery are likely to enhance.

[Measurement Method of D₁₀, D₅₀, and D₉₀]

In the present description, D₁₀, which is the 10% cumulative volume particle diameter, D₅₀, which is the 50% cumulative volume particle diameter, and D₉₀, which is the 90% cumulative volume particle diameter, of a subject to be measured can be measured by the following wet or dry method. The subject to be measured is CAM or the compound X to be described later.

Example of the wet measurement method include a measurement method using laser diffraction scattering method.

Specifically, 2 g of a powder subject to be measured is put in 50 ml of a 0.2 mass % sodium hexametaphosphate aqueous solution to obtain a dispersion in which the subject to be measured is dispersed.

Then, the particle size distribution of the obtained dispersion is measured using a laser diffraction particle size distribution meter to obtain a volume-based cumulative particle size distribution curve.

As the laser diffraction particle size distribution meter, for example, MS2000 manufactured by Malvern Instruments can be used.

When the measurement by the above wet method is difficult to perform, the following dry method is used for the measurement.

Specifically, using 2 g of a subject to be measured, dry particle size distribution is measured using a laser diffraction particle size distribution meter to obtain a volume-based cumulative particle size distribution curve.

As the laser diffraction particle size distribution meter, for example, MS2000 manufactured by Malvern Instruments can be used.

In the cumulative particle size distribution curve obtained by the wet or dry method, the particle diameter value at 10% cumulative from the side of the fine particle is the 10% cumulative volume particle diameter D₁₀ (μm), the particle diameter value at 50% cumulative from the side of the fine particle is the 50% cumulative volume particle diameter D₅₀(μm), and the particle diameter value at 90% cumulative from the side of the fine particle is the 90% cumulative volume particle diameter D₉₀ (μm).

CAM is measured by the wet method, and the compound X is measured by the wet or dry method depending on the kind of compound.

### [BET Specific Surface Area]

CAM has a BET specific surface area of preferably 0.2 to 2.5 m²/g, more preferably 0.5 to 2.5 m²/g, still more preferably 1.0 to 2.5 m²/g, and particularly preferably 1.5 m²/g or more. In addition, CAM may have a BET specific surface area of 1.5 to 2.5 m²/g, or 1.7 to 2.5 m²/g.

When CAM with a BET specific surface area having the above lower limit value or more is used, the output characteristic of the lithium secondary battery is likely to enhance.

When CAM with a BET specific surface area having the above upper limit value or less is used, the contact area between CAM and an electrolytic solution less likely to increase, a gas generation caused by electrolytic solution decomposition is likely to be suppressed.

### [Measurement of BET Specific Surface Area]

The BET specific surface area of a subject to be measured can be measured using a BET specific surface area meter. For the BET specific surface area meter, for example, Macsorb (registered trademark) manufactured by MOUNTECH Co., Ltd. can be used. When a powder subject to be measured is measured, it is preferable to dry the subject at 105° C. for 30 minutes as pretreatment in a nitrogen atmosphere. The subject to be measured is CAM or the compound X to be described later.

### [Composition Formula]

CAM is preferably represented by the following composition formula (I). CAM represented by the following composition formula (I) simultaneously contains LiMO and the Li—X compound.

Li[Liₐ(Ni_{(1-y-z-w)}Co_{y}M_{z}X_{w})₁₋ₐ]O₂ (I)

(In the composition (I), M is one or more elements selected from the group consisting of Mn, Fe, Cu, Ti, Mg, Al, Zn, Sn, Zr, Ga, B, Si, S, and P, X is one or more elements selected from the group consisting of Nb, W, and Mo, and the composition formula (I) satisfies −0.1≤a≤0.2, 0≤y≤0.5, 0<z≤0.7, 0<w≤0.1, and y+z+w<1.)

In the composition formula (I), a is, from the viewpoint of enhancing the cycle characteristics, preferably −0.02 or more, more preferably 0 or more, and particularly preferably 0.002 or more. In addition, a is, from the viewpoint of obtaining the lithium secondary battery with high initial discharge capacity and initial efficiency, preferably 0.1 or less, more preferably 0.08 or less, and particularly preferably 0.07 or less.

The above upper limit values and the lower limit values of a can be arbitrarily combined.

a preferably satisfies −0.02≤a≤0.1, more preferably 0≤a≤0.08, and particularly preferably 0.002≤a≤0.07.

In the composition formula (I), from the viewpoint of obtaining the lithium secondary battery with high discharge efficiency, it is preferable to satisfy 0<y+z+w<0.6, more preferable to satisfy 0<y+z+w≤0.5, still more preferable to satisfy 0<y+z+w≤0.25, and particularly preferable to satisfy 0<y+z+w≤0.2.

In the composition formula (I), y is, from the viewpoint of obtaining the lithium secondary battery with low battery internal resistance, more preferably 0.02 or more, and particularly preferably 0.04 or more. In addition, y is, from the viewpoint of obtaining the lithium secondary battery with high heat stability, preferably 0.4 or less, and particularly preferably 0.3 or less.

The upper limit values and the lower limit values of y can be arbitrarily combined. Examples of the combination of y include 0.02≤y≤0.4, and 0.04≤y≤0.3.

In the composition formula (I), z is, from the viewpoint of enhancing the cycle characteristics, more preferably 0.0002 or more, and particularly preferably 0.0005 or more. In addition, z is preferably 0.15 or less, more preferably 0.13 or less, and particularly preferably 0.1 or less.

The upper limit values and the lower limit values of z can be arbitrarily combined.

In the present embodiment, z preferably satisfies 0.0002≤z≤0.15, more preferably satisfies 0.0005≤z≤0.13, and particularly preferably satisfies 0.0005≤z≤0.1.

In the composition formula (I), w is, from the viewpoint of enhancing the cycle characteristics, more preferably 0.001 or more, and particularly preferably 0.002 or more. In addition, w is preferably 0.09 or less, more preferably 0.07 or less, and particularly preferably 0.05 or less.

The upper limit values and the lower limit values of w can be arbitrarily combined.

w preferably satisfies 0.001≤w≤0.09, preferably satisfies 0.002≤w≤0.07, and preferably satisfies 0.002≤w≤0.05. In addition, w may be 0.001≤w≤0.05.

It is preferable for the combination of a, y, z, and w to satisfy 0.002≤a≤0.07 and 0.04≤y≤0.3 and 0.0002≤z≤0.15 and 0.001≤w≤0.05.

### [Composition Analysis]

The composition analysis of CAM can be measured by dissolving a powder of the obtained CAM in hydrochloric acid, and then using an ICP emission spectrometer.

As the ICP emission spectrometer, for example, SPS3000 manufactured by Seiko Instruments Inc. can be used.

### (Layered Structure)

The crystal structure of CAM is a layered structure, and is more preferably a hexagonal crystal structure or a monoclinic crystal structure.

The hexagonal crystal structure belongs to any one of space group selected from the group consisting of P3, P31, P32, R3, P-3, R-3, P312, P321, P3112, P3121, P3212, P3221, R32, P3 m1, P31m, P3c1, P31c, R3m, R3c, P-31m, P-31c, P-3 m1, P-3c1, R-3m, R-3c, P6, P61, P65, P62, P64, P63, P-6, P6/m, P63/m, P622, P6122, P6522, P6222, P6422, P6322, P6 mm, P6cc, P63 cm, P63mc, P-6m2, P-6c2, P-62m, P-62c, P6/mmm, P6/mcc, P63/mcm, and P63/mmc.

The monoclinic crystal structure belongs to any one of space groups selected from the group consisting of P2, P21, C2, Pm, Pc, Cm, Cc, P2/m, P21/m, C2/m, P2/c, P21/c, and C2/c.

Of these, for obtaining the lithium secondary battery with high initial discharge capacity, the crystal structure is particularly preferably the hexagonal crystal structure belonging to the space group R-3m, or the monoclinic crystal structure belonging to C2/m.

### [Measurement Method of Initial Discharge Capacity, Initial Efficiency, and Cycle Retention]

Using CAM to be a subject to be evaluated for a positive electrode, a coin-type lithium secondary battery is produced. In the case of comparing physical properties of different CAMs, lithium secondary batteries having common battery configuration except CAM are produced and evaluated.

The assembled coin-type lithium secondary battery is allowed to stand at room temperature for 12 hours, thereby fully impregnating a separator and a positive electrode mixture layer with an electrolytic solution.

At a test temperature of 25° C., constant current constant voltage charging and constant current discharging are performed respectively with a current setting value of 0.2 CA for both charging and discharging. A negative electrode is a metal lithium, a maximum charge voltage is 4.3 V, and a minimum discharge voltage is 2.5 V. A charge capacity is measured, and the obtained value is defined as the “initial charge capacity” (mAh/g). In addition, a discharge capacity is measured, and the obtained value is defined as the “initial discharge capacity” (mAh/g).

Using the value of the initial discharge capacity and the value of the initial charge capacity, an initial efficiency is calculated by the following equation.

Initial efficiency (%)=initial discharge capacity (mAh/g)/initial charge capacity (mAh/g)×100

Subsequently, at a test temperature of 25° C., the constant current constant voltage charging and the constant current discharging are repeated under the following conditions. The number of charge and discharge cycle repetitions is 50 times.

Charge: current setting value 1 CA, maximum voltage 4.3 V, constant voltage constant current charging

Discharge: current setting value 1 CA, minimum voltage 2.5 V, constant current discharging

From the discharge capacity of the 1^{st} cycle and the discharge capacity of the 50^{th} cycle, a cycle retention is calculated using the following equation. The higher a cycle retention is, the less likely the battery capacity after repeating charge and discharge decreases, thereby meaning desirable battery performance.

Cycle retention (%)=discharge capacity (mAh/g) of 50^{th} cycle/discharge capacity (mAh/g) of 1^{st} cycle×100

In the present description, the “initial discharge capacity is high” means that the value of initial discharge capacity measured by the above method is 205 mAh/g or more. The “initial efficiency is high” means that the value of the initial efficiency measured by the above method is 88.0% or more. Additionally, the “cycle retention is high” means that the cycle retention measured by the above method is 80.0% or more.

The production method 1 of CAM is a method of performing in order of a production step of MCC, a step of mixing MCC, a lithium compound, and a compound X to obtain a mixture, and a step of obtaining CAM.

### [Production Step of MCC]

First, MCC containing Ni, an optional metal Co, and an element M is prepared.

MCC can be typically produced by a known batch coprecipitation method or continuous coprecipitation method. Hereinafter, the production method will be described in detail in reference to an example of a metal composite hydroxide containing, as metal elements, Ni, Co, and Al.

First, a nickel salt solution, a cobalt salt solution, an aluminum salt solution, and a complexing agent are reacted by a coprecipitation method, particularly by a continuous method described in JP-A-2002-201028, to produce a metal composite hydroxide represented by Ni_{(1-y-z)}Co_{y}Al_{z}(OH)₂ (wherein, y+z=1).

The nickel salt that is the solute in the above nickel salt solution, is not particularly limited, but any one, or two or more of, for example, nickel sulfate, nickel nitrate, nickel chloride, and nickel acetate can be used.

As the cobalt salt that is the solute in the above cobalt salt solution, any one, or two or more of, for example, cobalt sulfate, cobalt nitrate, cobalt chloride, and cobalt acetate can be used.

As the aluminum salt that is the solute in the above aluminum salt solution, for example, aluminum sulfate, sodium aluminate and the like can be used.

The above metal salts are used in the ratio corresponding to the composition ratio of the above Ni_{(1-y-z)}Co_{y}Al_{z}(OH)₂. In addition, water is used as a solvent.

The complexing agent is a compound capable of forming a complex with the ions of Ni, Co, and Al in the aqueous solution. Examples include ammonium ion donors, hydrazine, ethylenediaminetetraacetic acid, nitrilotriacetic acid, uracil diacetic acid, and glycine.

Examples of the ammonium ion donor include ammonium salts such as ammonium hydroxide, ammonium sulfate, ammonium chloride, ammonium carbonate, and ammonium fluoride.

The complexing agent may not be contained, but when the complexing agent is contained, regarding the amount of the complexing agent contained in a liquid mixture containing the nickel salt solution, the cobalt salt solution, the aluminum salt solution, and the complexing agent, a molar ratio to the total molar number of the metal salts is, for example, more than 0 and 2.0 or less.

In the coprecipitation method, the pH value of the liquid mixture containing the nickel salt solution, the cobalt salt solution, the aluminum salt solution, and the complexing agent is adjusted by adding an alkaline aqueous solution thereto before the pH of the liquid mixture becomes neutral from alkaline. As the alkaline aqueous solution, sodium hydroxide and potassium hydroxide can be used.

The value of pH in the present description is defined as the value measured when the temperature of the liquid mixture is 40° C. pH of the liquid mixture is measured at which the temperature of the liquid mixture sampled from a reaction vessel reaches 40° C.

When a temperature of the sampled liquid mixture is lower than 40° C., the liquid mixture is heated and pH is measured when the temperature reaches 40° C.

When a temperature of the sampled liquid mixture is higher than 40° C., the liquid mixture is cooled and pH is measured when the temperature reaches 40° C.

When the complexing agent is continuously supplied to the reaction vessel in addition to the nickel salt solution, the cobalt salt solution, and the aluminum salt solution, Ni, Co, and Al react, and Ni_{(1-y-z)}Co_{y}Al_{z}(OH)₂ is generated.

At the time of the reaction, the temperature of the reaction vessel is controlled within the range from, for example, 20 to 80° C., and preferably 30 to 70° C.

Additionally, at the time of the reaction, the pH value in the reaction vessel is controlled within the range of, for example, pH 9 to 13, and preferably pH 11 to 13.

The substances in the reaction vessel are suitably stirred and mixed.

As the reaction vessel used in the continuous coprecipitation method, the overflow type of reaction vessel can be used to separate the formed reaction precipitate.

The inside of the reaction vessel may be an inert atmosphere. In an inert atmosphere, elements that are more easily oxidized than nickel can be prevented from aggregating, and a uniform MCC can be obtained.

In addition, the inside of the reaction vessel may be an in an atmosphere moderately containing oxygen or in the presence of an oxidizing agent, while maintaining an inert atmosphere.

When an oxidation amount of transition metals is increased, a specific surface area becomes larger. Oxygen and the oxidizing agent in an oxygen-containing gas desirably have adequate oxygen atoms to oxidize transition metals. Unless a large amount of oxygen atoms is introduced, an inert atmosphere in the reaction vessel can be maintained. When the atmosphere control in the reaction vessel is performed using a gas species, the predetermined gas species is passed through the reaction vessel, or the reaction solution can be directly bubbled.

In addition to controlling the above conditions, various gases, for example, inert gases such as nitrogen, argon, and carbon dioxide, oxidized gases such as air and oxygen, or a mixed gas thereof are supplied to the reaction vessel, thereby controlling the oxidation state of reaction product to be obtained.

As compounds for oxidizing the reaction product to be obtained, peroxides such as hydrogen peroxide, peroxide salts such as permanganate, perchlorate, hypochlorite, nitric acid, halogen, and ozone can be used.

As compounds for reducing the reaction product to be obtained, organic acids such as oxalic acid and formic acid, sulfite, and hydrazine can be used.

After the above reaction, the obtained reaction product is washed with water and then dried to obtain MCC. In the present embodiment, a nickel cobalt aluminum metal composite hydroxide is obtained as MCC. In addition, when impurities derived from the liquid mixture remain in the reaction product that is washed only with water, the reaction product may be washed with weak acid water, or an alkaline solution containing sodium hydroxide or potassium hydroxide, as needed.

As drying time, the total time from the start of temperature rising to the end of temperature holding after reaching temperature is preferably 1 to 30 hours. The temperature rising rate to reach the highest holding temperature when dried is preferably 180° C./hour or more, more preferably 200° C./hour or more, and particularly preferably 250° C./hour or more.

The highest holding temperature in the present description refers to the highest temperature among the holding temperatures of the atmosphere inside a drying furnace or a calcination furnace (hereinafter, collectively referred to as “heating device”) when drying or in the calcination step to be described later (hereinafter, collectively referred to as “heating step”), and means the drying temperature and the calcination temperature, respectively. When a multiple times of the drying or calcination are performed in the heating step, the highest holding temperature means the highest temperature of the heating step.

The temperature rising rate in the present description is calculated from the time from the start of temperature rising to reaching the highest holding temperature in a heating device, and the temperature difference between the temperature at the start of temperature rising in the furnace of the heating device and the highest holding temperature.

The drying condition of MCC is not particularly limited. When MCC is a metal composite oxide or a metal composite hydroxide, the drying condition may be, for example, any of the following 1) to 3).
1) The condition under which the metal composite oxide or the metal composite hydroxide is not oxidized or reduced. Specifically, the drying condition under which the metal composite oxide remains as the metal composite oxide, and the drying condition under which the metal composite hydroxide remains as the metal composite hydroxide.
2) The condition under which the metal composite hydroxide is oxidized. Specifically, the drying condition under which the metal composite hydroxide is oxidized to the metal composite oxide.
3) The condition under which the metal composite oxide is reduced. Specifically, the drying condition under which the metal composite oxide is reduced to the metal composite hydroxide.

For achieving the condition under which the metal composite oxide or the metal composite hydroxide is not oxidized or reduced, an inert gas such as nitrogen, helium, and argon can be used as an atmosphere when drying.

For achieving the condition under which the metal composite hydroxide is oxidized, oxygen or air can be used in an atmosphere when drying. During this time, the metal composite hydroxide can be heated in a range from 400 to 700° C. for 0.1 to 20 hours.

Furthermore, for achieving the condition under which the metal composite oxide is reduced, a reducing agent such as hydrazine, and sodium sulfite is used under an inert gas atmosphere when drying.

After drying MCC, classification may be appropriately performed.

### [Step of Obtaining the Mixture]

After drying MCC, the lithium compound and the compound X are mixed.

When the mixture containing MCC, the lithium compound, and the compound X is calcined, CAM containing the Li—X compound in the gap of LiMO can be obtained. In the following description, the mixture containing MCC, the lithium compound, and the compound X may be described as Mixture 1.

When Mixture 1 is calcined, MCC and the lithium compound react, primary particles grows, and the primary particles aggregate and sinter to form secondary particles having gaps. As the sintering of the primary particles proceeds, the average crystallite diameter of CAM is likely to increase.

Furthermore, the lithium contained in the lithium compound reacts to the compound X, thereby forming the Li—X compound. The formed Li—X compound accumulates in the gaps.

As a result of consideration by the present inventors, it has been found that when the compound X is used, the effect of the hindrance on sintering of primary particles and crystal growth are reduced, and thus CAM with a fully developed layered structure is likely to be obtained. It is considered that the particle diameter and the specific surface area of the compound X adjusted in appropriate ranges enable to enhance the dispersibility of the compound X in MCC and the lithium compound, and to reduce the effect of the hinderance on sintering the primary particles by aggregates of the compound X.

As the lithium compound, any one of lithium carbonate, lithium nitrate, lithium acetate, lithium hydroxide, lithium hydroxide hydrate, and lithium oxide, or the mixture of two or more of them, can be used.

Of these lithium compounds, lithium hydroxide and lithium acetate react to carbon dioxide in the air and can contain several percent of lithium carbonate.

The compound X is a compound containing one or more elements selected from the group consisting of Nb, W, and Mo as the element X.

Examples of the compound X include niobium oxide (Nb₂O₅, NbO), and niobic acid when the element X is Nb.

Examples of the compound X include tungsten oxide (WO₃, WO₂), tungstic acid, and tungsten chloride when the element X is W.

Examples of the compound X include molybdenum oxide (MoO₃) when the element X is Mo.

The amount of the compound X to be added varies depending on the kind of the element X. The amount of the compound X to be added is suitably adjusted by the molar amount ratio of the element X to the total molar amount of the metal elements contained in the metal composite compound.

For example, the molar amount ratio of the element X contained in the compound X to the total molar amount of the metal elements contained in MCC is preferably 0.1 to 2.5 mol %.

From the viewpoint of not hindering the sintering of primary particles contained in LiMO and fully developing the layered structure of CAM particles, D₅₀ of the compound X is preferably 0.02 to 20 m, and more preferably 0.05 to 14 km.

To allow the Li—X compound to effectively exist in the gap of LiMO, the BET specific surface area of the compound X is preferably 5.0 to 15 m²/g.

When the compound X contains Nb as the element X, D₅₀ of the compound X is preferably 10 μm or less, more preferably 5.0 μm or less, and still more preferably 3.0 μm or less. In addition, D₅₀ of the compound X is preferably 0.02 μm or more, and particularly preferably 0.05 μm or more.

When the compound X contains Nb as the element X, the BET specific surface area of the compound X is preferably 5.5 to 15 m²/g, and more preferably 6.0 to 10 m²/g.

When the compound X contains Nb as the element X, it is preferable that D₅₀ is 0.05 to 3.0 m, and the BET specific surface area is 6.0 to 10.0 m²/g.

When the compound X contains W as the element X, D₅₀ of the compound X is preferably 10 μm or less, and more preferably 5.0 μm or less. In addition, D₅₀ of the compound X is preferably 0.02 μm or more, and particularly preferably 0.05 μm or more.

When the compound X contains W as the element X, the BET specific surface area of the compound X is preferably 4.0 to 15 m²/g, and more preferably 5.0 to 12.0 m²/g.

When the compound X contains W as the element X, it is preferable that D₅₀ is 0.05 to 5 m, and the BET specific surface area is 5.0 to 12.0 m²/g.

When the compound X contains Mo as the element X, D₅₀ of the compound X is preferably 10 μm or less, and more preferably 5.0 μm or less. In addition, D₅₀ of the compound X is preferably 0.02 μm or more, and particularly preferably 0.05 μm or more.

When the compound X contains Mo as the element X, the BET specific surface area of the compound X is preferably 4.0 to 15 m²/g, and more preferably 5.0 to 12.0 m²/g.

When the compound X contains Mo as the element X, it is preferable that D₅₀ is 0.05 to 5.0 m, and the BET specific surface area is 5.0 to 12.0 m²/g.

When the compound X having D₅₀ and the BET specific surface area within the above ranges is used, the sintering of primary particles is less likely hindered, and CAM containing the Li—X compound in the gap can be obtained, and further L_{A}, Lₐᵥ, and L_{A}/Lₐᵥ can be controlled in preferable ranges of the present embodiment.

MCC, the lithium compound, and the compound X are preferably mixed homogeneously until each of the aggregates is undetected. Mixing device is not limited as long as MCC, the lithium compound, and the compound X can be homogeneously mixed, and it is preferable to mix using, for example, a Loedige mixer.

The lithium compound, MCC, and the compound X are used in consideration of the composition ratio of the final target product. For example, when a nickel cobalt aluminum metal composite hydroxide is used as MCC, the lithium compound, MCC, and the compound X are used in the ratios corresponding to the composition ratio of Li[Liₐ(Ni_{(1-y-z-w)}Co_{y}Al_{z}X_{w})₁₋ₐ]O₂ (in formula, y+z+w=1).

In addition, in CAM, which is the final target product, when Li contained in the lithium compound and the metal elements contained in MCC are mixed in a ratio so that the molar ratio is 0.98 to 1.10, L_{A}/Lₐᵥ of CAM to be obtained is easily controlled in a preferable range of the present embodiment.

### [Step of Obtaining the Positive Electrode Active Material]

When the mixture of MCC, the lithium compound, and the compound X is calcined, CAM having LiMO and the Li—X compound in the gap can be obtained. For example, when the mixture of the nickel cobalt aluminum metal composite hydroxide, the lithium compound, and the compound X is calcined, CAM having the lithium-nickel cobalt aluminum metal composite oxide as LiMO and the Li—X compound in the gap can be obtained. For the calcination, dry air, oxygen atmosphere, inert atmosphere and the like are used according to the desired composition. In the present embodiment, it is preferable to calcine in an oxygen atmosphere.

The calcination step may be performed only once, or may also include multiple times of calcination processes.

When the calcination step has a multiple times of calcination processes, the step in which the calcination is performed at the highest temperature is described as the main calcination. Before the main calcination, a preliminary calcination in which calcination is performed at a lower temperature than the main calcination can be performed. In addition, a post calcination in which calcination is performed at a lower temperature than the main calcination can be performed after the main calcination.

The calcination temperature in the main calcination (highest holding temperature) is, from the viewpoint of promoting the growth of the lithium composite compound particles, preferably 600° C. or more, more preferably 650° C. or more, and particularly preferably 700° C. or more. In addition, from the viewpoint of preventing the formation of cracks in LiMO particles and maintaining the particle strength, the main calcination temperature is preferably 1200° C. or less, more preferably 1100° C. or less, and particularly preferably 1000° C. or less.

The upper limit values and the lower limit values of the highest holding temperature in the main calcination can be arbitrarily combined.

Examples of the combination include 600 to 1200° C., 650 to 1100° C., and 700 to 1000° C.

When the main calcination is performed at 600° C. or more, L_{A}, Lₐᵥ, and L_{A}/Lₐᵥ of CAM to be obtained are easily controlled in preferable ranges of the present embodiment.

The calcination temperatures in the preliminary calcination or the post calcination can be lower than the calcination temperature in the main calcination, and, for example, is a range from 350 to 800° C.

The highest temperature in the calcination can be suitably adjusted according to the kind of transition metal elements, and the kind and amount of a precipitant and inert dissolving agent to be used.

In addition, the time for holding the above holding temperature is 0.1 to 20 hours, and preferably 0.5 to 10 hours. The temperature rising rate to the highest temperature is typically 50 to 400° C./hour, and the temperature falling rate to room temperature from the highest temperature is typically 10 to 400° C./hour. Furthermore, as the calcination atmosphere, atmosphere, oxygen, nitrogen, argon, or a mixed gas of these can be used.

### [Optional Step]

### Washing Step

In the present embodiment, it is preferable to wash the calcined product after calcination with a washing liquid such as pure water, and an alkaline washing liquid.

Examples of the alkaline washing liquid include aqueous solutions of one or more anhydrous selected from the group consisting of LiOH (lithium hydroxide), NaOH (sodium hydroxide), KOH (potassium hydroxide), Li₂CO₃ (lithium carbonate), Na₂CO₃ (sodium carbonate), K₂CO₃ (potassium carbonate), and (NH₄)₂CO₃ (ammonium carbonate), and aqueous solutions of hydrates of the above anhydrides. Additionally, ammonia can also be used as alkali.

In the washing step, as the method for bringing the washing liquid and the calcined product into contact with each other, a method in which the calcined product is injected into each washing liquid and stirred, and a method in which each washing liquid is sprayed onto the calcined product as shower water. As the method in which each washing liquid is sprayed onto the calcined product as shower water, a method in which the calcined product is injected into the washing liquid and stirred, and separated from each washing liquid, and then each washing liquid is sprayed onto the separated calcined product as shower water.

The temperature of the washing liquid used for washing is preferably 15° C. or less, more preferably 10° C. or less, and still more preferably 8° C. or less. When the temperature of the washing liquid is controlled in the above range so that the washing liquid does not freeze, it is possible to suppress the excess elution of lithium ions from the crystal structure of the calcined product to the washing liquid during washing.

The washed calcined product may be suitably dried.

CAM can be obtained by the above steps.

### <Production Method 2 of Positive Electrode Active Material>

The production method of CAM of the present embodiment is a method of performing in order of a production step of MCC, a step of mixing MCC and the lithium compound to obtain LiMO, and a step of mixing and calcining LiMO and the compound X to obtain CAM.

### [Production Step of MCC]

The descriptions regarding the production step of MCC in the production method 2 of CAM are the same as the descriptions regarding the production step of MCC in the production method 1 of CAM.

### [Step of Obtaining the Lithium Composite Metal Compound]

The obtained MCC and the lithium compound are mixed. A mixture containing MCC and the lithium compound is calcined, to obtain LiMO.

The lithium compound used in the present step can be the same compound as the lithium compound described in the production method 1 of CAM.

The lithium compound and MCC described above are used in consideration of the composition ratio of the final target product. For example, when a nickel cobalt aluminum metal composite hydroxide is used as MCC, the lithium compound and MCC are used in the ratios corresponding to the composition ratio of Li[Liₐ(Ni_{(1-y-z)}Co_{y}Al_{z})₁₋ₐ]O₂ (in formula, y+z=1). In addition, in CAM, which is the final target product, when Li contained in the lithium compound and the metal elements contained in MCC are mixed in a ratio so that the molar ratio is 0.98 to 1.10, L_{A}, Lₐᵥ, and L_{A}/Lₐᵥ of CAM to be obtained are easily controlled in preferable ranges of the present embodiment.

When the mixture of the nickel cobalt aluminum metal composite hydroxide and the lithium compound are calcined, a lithium-nickel cobalt aluminum metal composite oxide can be obtained. For the calcination, dry air, oxygen atmosphere, inert atmosphere and the like are used according to the desired composition.

The calcination step of calcining the mixture of the nickel cobalt aluminum metal composite hydroxide and the lithium compound is preferably a single calcination.

Hereinbelow, the calcination of the mixture of the nickel cobalt aluminum metal composite hydroxide and the lithium compound is described as the primary calcination.

The temperature for the primary calcination can be lower than the calcination temperature of the secondary calcination to be described later, and is a range from 350 to 800° C.

### [Step of Obtaining CAM]

The calcined product obtained after the primary calcination and the compound X are mixed and further calcined, to obtain CAM. The step of mixing and calcining the calcined product obtained after the primary calcination and the compound X is described as the secondary calcination.

MCC and the lithium compound react by the primary calcination, the primary particles grow, and the primary particles aggregate and sinter to form secondary particles having gaps. When the calcined product obtained after the primary calcination and the compound X are mixed and subjected to the secondary calcination, the Li—X compound is likely to accumulate in the gap as in the production method 1 of CAM.

The descriptions regarding the compound X used in the production method 2 of CAM are the same as the descriptions regarding the compound X in the production method 1 of CAM.

The calcination temperature in the secondary calcination (highest holding temperature) is, from the viewpoint of allowing the Li—X compound to homogeneously exist in the gap, preferably 600° C. or more, more preferably 650° C. or more, and particularly preferably 700° C. or more. In addition, from the viewpoint of preventing the formation of cracks in CAM particles and maintaining the particle strength, the calcination temperature is preferably 1200° C. or less, more preferably 1100° C. or less, and particularly preferably 1000° C. or less.

The upper limit values and the lower limit values of the highest holding temperature in the secondary calcination can be arbitrarily combined.

Examples of the combination include 600 to 1200° C., 650 to 1100° C., and 700 to 1000° C.

When the secondary calcination is performed at 600° C. or more, L_{A}, Lₐᵥ, and L_{A}/Lₐv of CAM to be obtained are easily controlled in preferable ranges of the present embodiment.

The highest temperature in the calcination can be suitably adjusted according to the kind of transition metal elements, the kind and amount of a precipitant and inert dissolving agent to be used.

In addition, the time for holding the above holding temperature is 0.1 to 20 hours, and preferably 0.5 to 10 hours. The temperature rising rate to the highest temperature is typically 50 to 400° C./hour, and the temperature falling rate to room temperature from the highest temperature is typically 10 to 400° C./hour. Furthermore, as the calcination atmosphere, atmosphere, oxygen, nitrogen, argon, or a mixed gas of these can be used.

The amount of the compound X to be added is adjusted according to the kind of element X to be a ratio so that the molar amount ratio of the element X to the total molar amount of the metal elements other than the Li contained in LiMO is in a preferred range.

For example, in the production step of CAM, when a compound containing at least one selected from the group consisting of Nb, W, and Mo as the element X is used, the ratio of molar amount of the element X to the total molar amount of the metal elements other than the Li contained in LiMO is preferably 0.1 to 2.5 mol %.

The compound X and LiMO are homogeneously mixed until aggregates of the compound X or excess aggregates of LiMO are undetected. Mixing device is not limited as long as the compound X and LiMO can be homogeneously mixed, and it is preferable to mix using, for example, a Loedige mixer.

### [Optional Step]

The descriptions regarding the optional step in the production method 2 of CAM are the same as the descriptions regarding the optional step in the production method 1 of CAM.

### <Lithium Secondary Battery>

Next, a preferable configuration of the lithium secondary battery in a case where CAM of the present embodiment is used will be described.

In addition, a preferable positive electrode for a lithium secondary battery (hereinafter, referred to as the positive electrode in some cases) in a case where CAM of the present embodiment is used will be described.

Furthermore, a preferable lithium secondary battery for an application of the positive electrode will be described.

An example of a preferable lithium secondary battery in a case where CAM of the present embodiment is used has a positive electrode and a negative electrode, a separator interposed between the positive electrode and the negative electrode, and an electrolytic solution arranged between the positive electrode and the negative electrode.

An example of the lithium secondary battery has a positive electrode and a negative electrode, a separator interposed between the positive electrode and the negative electrode, and an electrolytic solution disposed between the positive electrode and the negative electrode.

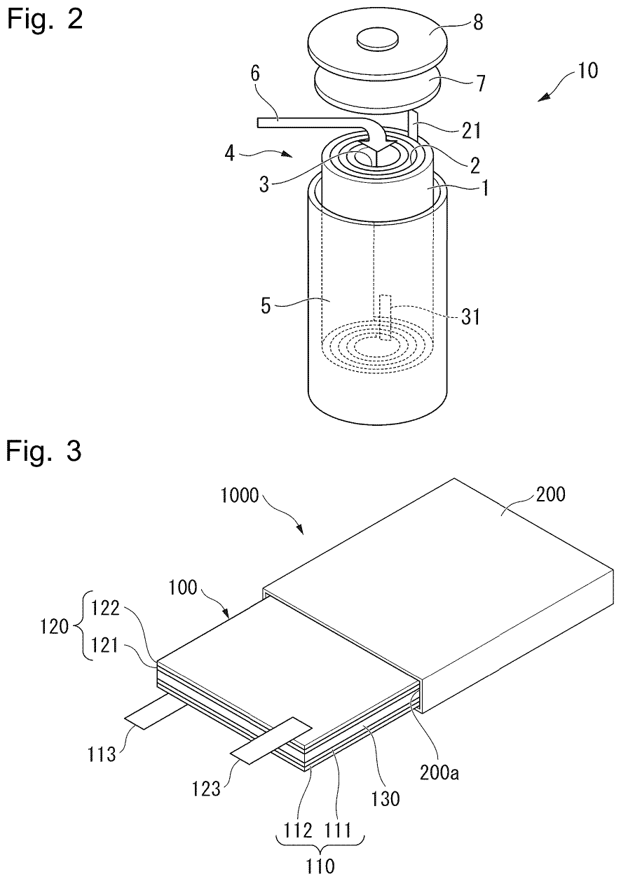

FIG. 2 is a schematic view showing an example of a lithium secondary battery. A cylindrical lithium secondary battery 10 is produced as follows.

First, as shown in FIG. 2, a pair of separator 1 having strip shape, a strip-shaped positive electrode 2 having a positive electrode lead 21 at one end, and a strip-shaped negative electrode 3 having a negative electrode lead 31 at one end are laminated in order of the separator 1, the positive electrode 2, the separator 1, and the negative electrode 3, and are wound to form an electrode group 4.

Subsequently, the electrode group 4 and an insulator, not shown, are accommodated in a battery can 5, then the bottom of the can is sealed, the electrode group 4 is impregnated with an electrolytic solution 6, and an electrolyte is disposed between the positive electrode 2 and the negative electrode 3. Furthermore, the upper part of the battery can 5 is sealed with a top insulator 7 and a sealing body 8, so that the lithium secondary battery 10 can be produced.

Examples of the shape of the electrode group 4 include a columnar shape in which the cross-sectional shape becomes a circle, an ellipse, a rectangle, or rectangle with rounded corners when the electrode group 4 is cut in a direction perpendicular to the winding axis.

In addition, as a shape of the lithium secondary battery having such an electrode group 4, a shape defined by IEC60086, which is a standard for batteries established by the International Electrotechnical Commission (IEC), or by JIS C 8500 can be adopted. For example, shapes such as cylindrical and square shapes can be exemplary examples.

Furthermore, the lithium secondary battery is not limited to the above winding-type configuration, and may have a laminated-type configuration in which the laminate structure of the positive electrode, the separator, the negative electrode, and the separator is repeatedly overlaid. As the laminated-type lithium secondary battery, a so-called coin-type battery, button-type battery, or paper-type (or sheet-type) battery can be an exemplary example.

Hereinafter, each configuration will be described in order.

### (Positive Electrode)

The positive electrode can be produced by first preparing a positive electrode mixture containing CAM, a conductive material, and a binder, and supporting the positive electrode mixture by a positive electrode current collector.

### (Negative Electrode)

The negative electrode of the lithium secondary battery can be any negative electrode which can be doped and dedoped with lithium ions at a lower electric potential than the positive electrode, and an electrode in which a negative electrode mixture containing a negative electrode active material is supported on a negative electrode current collector, and an electrode consisting of a negative electrode active material alone can be exemplary examples.

For the positive electrode, the separator, the negative electrode, and the electrolytic solution that configure the lithium secondary battery, the configuration, materials, and production method described in, for example, [0113] to [0140] of WO2022/113904 A1 can be used.

### <All-Solid-State Lithium Secondary Battery>

Next, a positive electrode using CAM according to an aspect of the present invention as CAM for an all-solid-state lithium secondary battery, and the all-solid-state lithium secondary battery having such a positive electrode will be described, while describing the configuration of an all-solid-state lithium secondary battery.

FIG. 3 is a schematic view showing an example of the all-solid-state lithium secondary battery of the present embodiment. An all-solid-state lithium secondary battery 1000 shown in FIG. 3 has a laminate 100 having a positive electrode 110, a negative electrode 120, and a solid electrolyte layer 130, and an exterior body 200 accommodating the laminate 100. In addition, the all-solid-state lithium secondary battery 1000 may have a bipolar structure in which a positive electrode active material and a negative electrode active material are disposed on both sides of a current collector. As specific examples of the bipolar structure, for example, the structure described in JP-A-2004-95400 are exemplary examples. Materials constituting each member will be described later.

The laminate 100 may have an external terminal 113 connected to the positive electrode current collector 112 and an external terminal 123 connected to the negative electrode current collector 122. In addition, the all-solid-state lithium secondary battery 1000 may have a separator between the positive electrode 110 and the negative electrode 120.

The all-solid-state lithium secondary battery 1000 further has an insulator, not shown, that insulates the laminate 100 and the exterior body 200 from each other, and a sealant, not shown, that seals an opening portion 200a of the exterior body 200.

As the exterior body 200, a container formed by molding a highly corrosion-resistant metal material such as aluminum, stainless steel, or nickel-plated steel can be used.

In addition, as the exterior body 200, a container formed by processing a laminated film having at least one surface on which a corrosion resistant process has been performed into a bag shape can be used.

As the shape of the all-solid-state lithium secondary battery 1000, for example, shapes such as coin type, button type, paper type (or sheet type), cylindrical type, square type, and laminated type (pouch type) can be exemplary examples.

As an example of the all-solid-state lithium secondary battery 1000, a form having one laminate 100 is shown in the drawings, but the present embodiment is not limited thereto. The all-solid-state lithium secondary battery 1000 may have a configuration in which the laminate 100 is used as a unit cell, and a plurality of unit cells (laminate 100) are sealed inside the exterior body 200.

### (Positive Electrode)

The positive electrode 110 of the present embodiment has a positive electrode active material layer 111 and a positive electrode current collector 112.

The positive electrode active material layer 111 contains CAM, which is one aspect of the present invention described above, and a solid electrolyte. In addition, the positive electrode active material layer 111 may contain a conductive material and a binder.

### (Negative Electrode)

The negative electrode 120 has a negative electrode active material layer 121 and a negative electrode current collector 122. The negative electrode active material layer 121 contains a negative electrode active material. In addition, the negative electrode active material layer 121 may contain a solid electrolyte and a conductive material. As the negative electrode active material, the negative electrode current collector, the solid electrolyte, the conductive material, and the binder, those described above can be used.

For the all-solid-state lithium secondary battery, the configuration, materials, and production method described in, for example, [0151] to [0181] of WO2022/113904 Å1 can be used.

In the lithium secondary battery having the above configuration, since CAM produced by the present embodiment described above is used, the initial discharge capacity, initial efficiency, and cycle retention of the lithium secondary battery using CAM can be improved.

In addition, the positive electrode having the above configuration can improve the initial discharge capacity, initial efficiency, and cycle retention of the lithium secondary battery because of CAM having the above-described configuration.

Furthermore, the lithium secondary battery having the above configuration has the above-described positive electrode, and thus become a secondary battery with high initial discharge capacity, initial efficiency, and cycle retention.

The present invention may further include the following aspects.

[11] CAM, containing LiMO and the Li—X compound containing Li and the element X, in which the Li—X compound is a lithium-ion conductive oxide, LiMO contains secondary particles which are aggregates of primary particles, the secondary particles have gaps among the primary particles, the Li—X compound is present at least in the gap, the element X is one or more elements selected from the group consisting of Nb, W and Mo, and CAM satisfies the above (A)-15.

[12] CAM according to [11], in which D₅₀ of CAM is 8 to 15 m.

[13] CAM according to [11] or [12], in which the BET specific surface area of CAM is 1.0 to 2.5 m²/g.

[14] CAM according to any one of [11] to [13], represented by the above composition formula (I).

[15] CAM according to any one of [11] to [14], in which D₁₀, D₉₀, and D₅₀ satisfy the above (B)-13.

[16] CAM according to any one of [11] to [15], in which Lₐᵥ is 100 to 130 Å.

[17] CAM according to any one of [11] to [16], in which L_{A} is 520 to 680 Å.

[18] CAM according to [13], in which the BET specific surface area is 1.5 m²/g or more.

[19] A positive electrode for a lithium secondary battery containing CAM according to any one of [11] to [18].

[20] A lithium secondary battery having the positive electrode for the lithium secondary battery according to [19].

### Examples

Next, the present invention will be described further in detail in reference to examples.

### <Composition Analysis>

The composition analysis of CAM produced by the method to be described later was performed by the method described in the above section [Composition analysis].

<Measurement of L_{A} and Lₐᵥ>

L_{A} and Lₐᵥ of CAM produced by the method to be described later were performed by the methods described in the above section [Measurement method of L_{A}] and

### [Measurement Method of Lₐᵥ].

L_{A}/Lₐᵥ was calculated from each value of the obtained L_{A} and Lₐᵥ.

### <Confirmation Method of the Li—X Compound>

The confirmation method of the Li—X compound in CAM produced by the method to be described later was performed by the method described in the above section

### [Confirmation Method of Li—X Compound].

### <Measurement of BET Specific Surface Area>

The BET specific surface area of CAM produced by the method to be described later was performed by the method described in the above section [Measurement of BET specific surface area]. The compound X was also measured for the BET specific surface area by the same method.

<Measurement of D₁₀, D₅₀ and D₉₀>

The cumulative volume particle diameter of CAM produced by the method to be described later was performed by the method described in the above section [Measurement method of D₁₀, D₅₀ and D₉₀]. The compound X was also measured by the same method.

### <Measurement Method of Initial Discharge Capacity, Initial Efficiency, and Cycle Retention>

The initial discharge capacity, the initial efficiency, and the cycle retention were measured by the method described in the above section [Measurement method of initial discharge capacity, initial efficiency, and cycle retention].

### Example 1

### 1. Production of CAM-1

After water was poured into a reaction vessel equipped with a stirrer and an overflow pipe, a sodium hydroxide aqueous solution was added thereto, and the liquid temperature was held at 50° C.

A nickel sulfate aqueous solution, a cobalt sulfate aqueous solution, and an aluminum sulfate aqueous solution were mixed together in a ratio so that the atomic ratio of Ni, Co, and Al was 88:9:3, to prepare a raw material-mixed liquid.

Subsequently, the raw material-mixed liquid and an ammonium sulfate aqueous solution, as a complexing agent, were continuously added into the reaction vessel under stirring. A sodium hydroxide aqueous solution was timely added dropwise so that pH of the solution in the reaction vessel was 11.6 (measured at a liquid temperature of 40° C.), to obtain particles of a nickel cobalt aluminum composite hydroxide.

The particles of the nickel cobalt aluminum composite hydroxide were washed, dehydrated using a centrifugal separator, isolated, and dried at 105° C., to obtain a nickel cobalt aluminum composite hydroxide 1.

The nickel cobalt aluminum composite hydroxide 1 was held and heated at 650° C. for 5 hours in an air atmosphere, and cooled to room temperature, thereby obtaining a nickel cobalt aluminum composite oxide 1.

The nickel cobalt aluminum composite oxide 1 and a lithium hydroxide monohydrate powder were weighed and mixed in the ratio so that the molar ratio was Li/(Ni+Co+Al)=1.10.

In addition, Nb₂O₅ was weighed and mixed in the ratio so that the molar ratio was Nb/(Ni+Co+Al)=0.01.

Nb₂O₅ used in Example 1 had a BET specific surface area of 7.19 m²/g, and D₅₀ of 1.26 μm.

Then, the mixture was preliminary calcined at 650° C. for 5 hours under an oxygen atmosphere.

Then, the calcined product was further main calcined at 760° C. for 6 hours under an oxygen atmosphere.

Then, the calcined product was washed with water, dried at 150° C. for 12 hours under reduced pressure, to obtain CAM-1.

### 2. Evaluation on CAM-1

As the result of performing out the composition analysis of CAM-1, a was 0.03, y was 0.09, z was 0.03, and w was 0.009, the element X was Nb, and the element M was Al. Additionally, the presence of the element X in the region equivalent to the gap was confirmed. The XAFS analysis was performed on CAM-1 and confirmed the formation of lithium niobate as the Li—X compound. Thus, it was confirmed that the Li—X compound was present at least in the gap.

### Example 2

### 1. Production of CAM-2

An experiment was performed in the same manner as Example 1, except that the calcination temperature of 760° C. in Example 1 was changed to 790° C., to obtain CAM-2.

### 2. Evaluation on CAM-2

As the result of performing the composition analysis of CAM-2, a was 0.01, y was 0.09, z was 0.03, and w was 0.008, the element X was Nb, and the element M was Al. Additionally, the presence of the element X in the region equivalent to the gap was confirmed. The XAFS analysis was performed on CAM-2 and confirmed the formation of lithium niobate as the Li—X compound. Thus, it was confirmed that the Li—X compound was present at least in the gap.

### Example 3

### 1. Production of CAM-3

The nickel cobalt aluminum composite hydroxide 1 and a lithium hydroxide monohydrate powder were weighed and mixed in the ratio so that the molar ratio was Li/(Ni+Co+Al)=1.10.

The obtained mixture was calcined at 650° C. for 5 hours under an oxygen atmosphere, to obtain a calcined product.

The calcined product and Nb₂O₅ described in Example 1 were weighed and mixed in the ratio so that the molar ratio was Nb/(Ni+Co+Al)=0.01.

Then, the mixture was calcined at 760° C. for 6 hours under an oxygen atmosphere.

Then, the calcined product was washed with water, dried at 150° C. for 12 hours under reduced pressure, to obtain CAM-3.

### 2. Evaluation on CAM-3

As the result of performing the composition analysis of CAM-3, a was 0.01, y was 0.09, z was 0.03, and w was 0.01, the element X was Nb, and the element M was Al. Additionally, the presence of the element X in the region equivalent to the gap was confirmed. The XAFS analysis was performed on CAM-3 and confirmed the formation of the Li—X compound. Thus, it was confirmed that the Li—X compound was present at least in the gap.

### Example 4

### 1. Production of CAM-4

The nickel cobalt aluminum composite hydroxide 1 and a lithium hydroxide monohydrate powder were weighed and mixed in the ratio so that the molar ratio was Li/(Ni+Co+Al)=1.03.

In addition, WO₃ was weighed and mixed in the ratio so that the molar ratio was W/(Ni+Co+Al)=0.005.

WO₃ used in Example 4 had a BET specific surface area of 7.12 m²/g, and D₅₀ of 0.25 μm.

Then, the mixture was preliminary calcined at 650° C. for 5 hours under an oxygen atmosphere.

Then, the calcined product was further main calcined at 790° C. for 6 hours under an oxygen atmosphere.

Then, the calcined product was washed with water, dried at 210° C. for 10 hours under a nitrogen atmosphere, to obtain CAM-4.

### 2. Evaluation on CAM-4

As the result of performing the composition analysis of CAM-4, a was 0.01, y was 0.09, z was 0.03, and w was 0.003, the element X was W, and the element M was Al. Additionally, the presence of the element X in the region equivalent to the gap was confirmed. The XAFS analysis was performed on CAM-4 and confirmed the formation of lithium tungstate as the Li—X compound. Thus, it was confirmed that the Li—X compound was present at least in the gap.

### Example 5

### 1. Production of CAM-5

After water was poured into a reaction vessel equipped with a stirrer and an overflow pipe, ta sodium hydroxide aqueous solution was added thereto, and the liquid temperature was held at 50° C.

A nickel sulfate aqueous solution, a cobalt sulfate aqueous solution, and a manganese sulfate aqueous solution were mixed together in a ratio so that the atomic ratio of Ni, Co, and Mn was 88:9:3, thereby preparing a raw material-mixed liquid.

Subsequently, the raw material-mixed liquid and an ammonium sulfate aqueous solution, as a complexing agent, were continuously added into the reaction vessel under stirring. A sodium hydroxide aqueous solution was timely added dropwise so that pH of the solution in the reaction vessel was 11.5 (measured at a liquid temperature of 40° C.), to obtain particles of a nickel cobalt manganese composite hydroxide.

The particles of the nickel cobalt manganese composite hydroxide were washed, dehydrated using a centrifugal separator, isolated, and dried at 105° C., thereby obtaining a nickel cobalt manganese composite hydroxide 1.

The nickel cobalt manganese composite hydroxide 1 and a lithium hydroxide monohydrate powder were weighed and mixed in the ratio so that the molar ratio was Li/(Ni+Co+Mn)=1.10.

In addition, Nb₂O₅ used in Example 1 was weighed and mixed in the ratio so that the molar ratio was Nb/(Ni+Co+Mn)=0.01.

Then, the mixture was preliminary calcined at 650° C. for 5 hours under an oxygen atmosphere.

Then, the calcined product was further main calcined at 790° C. for 5 hours under an oxygen atmosphere.

Then, the calcined product was washed with water, and post calcined at 700° C. for 5 hours under an oxygen atmosphere, to obtain CAM-5.

### 2. Evaluation on CAM-5

As the result of performing the composition analysis of CAM-5, a was 0.06, y was 0.09, z was 0.03, and w was 0.01, the element X was Nb, and the element M was Mn.

Additionally, the presence of the element X in the region equivalent to the gap was confirmed. The XAFS analysis was performed on CAM-5 and confirmed the formation of lithium niobate as the Li—X compound. Thus, it was confirmed that the Li—X compound was present at least in the gap.

### Comparative Example 1

### 1. Production of CAM-6

An experiment was performed in the same manner as Example 3, except that Nb₂O₅ having a BET specific surface area of 19.46 m²/g and D₅₀ of 34.0 μm was used, to obtain CAM-6.

### 2. Evaluation on CAM-6

As the result of performing the composition analysis of CAM-6, a was 0.05, y was 0.09, z was 0.03, and w was 0.01, the element X was Nb, and the element M was Al. Additionally, the presence of the element X in the region equivalent to the gap was confirmed. The XAFS analysis was performed on CAM-6 and confirmed the formation of lithium niobate as the Li—X compound. Thus, it was confirmed that the Li—X compound was present at least in the gap.

### Comparative Example 2

### 1. Production of CAM-7

An experiment was performed in the same manner as Example 3, except that Nb₂O₅ having a BET specific surface area of 5.27 m²/g and D₅₀ of 1.30 μm was used, to obtain CAM-7.

### 2. Evaluation on CAM-7

As the result of performing the composition analysis of CAM-7, a was 0.02, y was 0.09, z was 0.03, and w was 0.001, the element X was Nb, and the element M was Al. Additionally, the presence of the element X in the region equivalent to the gap was confirmed. The XAFS analysis was performed on CAM-7 and confirmed the formation of lithium niobate as the Li—X compound. Thus, it was confirmed that the Li—X compound was present at least in the gap.

### Comparative Example 3

### 1. Production of CAM-8

The nickel cobalt aluminum composite hydroxide 1 and a lithium hydroxide monohydrate powder were weighed and mixed in the ratio so that the molar ratio was Li/(Ni+Co+Al)=1.10.

Then, the mixture was calcined at 650° C. for 5 hours under an oxygen atmosphere.

Then, the calcined product was further calcined at 720° C. for 6 hours under an oxygen atmosphere, to obtain a calcine product.

The calcined product and Nb₂O₅ described in Example 1 were weighed and mixed in a ratio so that the molar ratio was Nb/(Ni+Co+Al)=0.01.

Then, the mixture was calcined at 400° C. for 5 hours under an oxygen atmosphere.

Then, the calcined product was washed with water, and dried at 150° C. for 12 hours under reduced pressure, to obtain CAM-8.

### 2. Evaluation on CAM-8

As the result of performing the composition analysis of CAM-8, a was 0.004, y was 0.09, z was 0.03, and w was 0.01, the element X was Nb, and the element M was Al. Additionally, the presence of the element X in the region equivalent to the gap was confirmed. The XAFS analysis was performed on CAM-8 and confirmed the formation of lithium niobate as the Li—X compound. Thus, it was confirmed that the Li—X compound was present at least in the gap.

### Comparative Example 4

### 1. Production of CAM-9

The nickel cobalt aluminum composite hydroxide 1 and a lithium hydroxide monohydrate powder were weighed and mixed in the ratio so that the molar ratio was Li/(Ni+Co+Al)=1.10.

Then, the mixture was preliminary calcined at 650° C. for 5 hours under an oxygen atmosphere.

Then, the calcined product was further main calcined at 720° C. for 6 hours under an oxygen atmosphere.

Then, the calcined product was washed with water, and dried at 210° C. for 12 hours under a nitrogen atmosphere, to obtain CAM-9.

### 2. Evaluation on CAM-9

As the result of performing the composition analysis of CAM-9, a was 0.028, y was 0.089, z was 0.026, and w was 0, the element X was not contained, and the element M was Al.

Table 1 shows the results of L_{A}/Lₐᵥ, L_{A}, Lₐᵥ, BET specific surface area, D₅₀, (D₉₀−D₅₀)/(D₅₀−D₁₀), initial discharge capacity, initial efficiency, and cycle retention of CAM-1 to CAM-9, respectively.

TABLE 1

| | | | | | BET | | | | |
|---|---|---|---|---|---|---|---|---|---|
| | | | | | Specific | (D₉₀ − | Initial | | |
| | | | | | surface | D₅₀/ | discharge | Initial | Cycle |
| | | Lₐᵥ | L_{A} | D₅₀ | area | (D₅₀ − | capacity | efficiency | retention |
| | L_{A}/Lₐᵥ | (Å) | (Å) | (μm) | (m²/g) | D₁₀) | (mAh/g) | (%) | (%) |
| Example 1 | 5.92 | 104.5 | 619.0 | 13.0 | 1.7 | 1.68 | 211 | 92.3 | 84.2 |
| Example 2 | 5.38 | 119.7 | 644.1 | 13.4 | 1.7 | 1.73 | 207 | 89.2 | 85.4 |
| Example 3 | 5.10 | 121.3 | 618.7 | 12.7 | 1.9 | 1.68 | 205 | 90.5 | 80.7 |
| Example 4 | 5.50 | 118.9 | 654.6 | 13.4 | 2.3 | 1.65 | 205 | 88.4 | 91.5 |
| Example 5 | 5.53 | 120.9 | 669.3 | 13.8 | 0.7 | 1.60 | 212 | 90.3 | 80.7 |
| Comparative | 4.84 | 143.7 | 695.5 | 13.0 | 1.4 | 1.61 | 201 | 88.3 | 82.9 |
| Example 1 | | | | | | | | | |
| Comparative | 4.92 | 143.3 | 705.6 | 12.5 | 1.7 | 1.72 | 208 | 91.5 | 78.5 |
| Example 2 | | | | | | | | | |
| Comparative | 4.78 | 150.1 | 716.7 | 13.3 | 1.1 | 1.79 | 193 | 83.2 | 76.5 |
| Example 3 | | | | | | | | | |
| Comparative | 5.19 | 136.5 | 708.0 | 13.5 | 1.4 | 1.63 | 204 | 87.8 | 88.3 |
| Example 4 | | | | | | | | | |

As shown in the above results, Examples 1 to 5 in which CAMs of the present embodiment were used had excellent initial discharge capacities, initial efficiencies, and cycle retentions.

On the other hand, Comparative Examples 1 to 3 in which L_{A}/Lₐᵥ does not satisfy the range of the present invention had poorer initial discharge capacities, initial efficiencies, and cycle retentions than the Examples, which is considered to be owing to the increased crystal factors that become the resistance during the insertion and desorption of lithium ions. Additionally, Comparative Example 4 which does not contain the element X had a poorer initial discharge capacity, initial efficiency, and cycle retention than the Examples.

### REFERENCE SIGNS LIST

1 . . . Separator, 2 . . . Positive electrode, 3 . . . Negative electrode, 4 . . . Electrode group, 5 . . . Battery can, 6 . . . Electrolytic solution, 7 . . . Top insulator, 8 . . . Sealing body, 10 . . . Lithium secondary battery, 21 . . . Positive electrode lead, 31 . . . Negative electrode lead, 100 . . . Laminate, 110 . . . Positive electrode, 111 . . . Positive electrode active material layer, 112 . . . Positive electrode current collector, 113 . . . External terminal, 120 . . . Negative electrode, 121 . . . Negative electrode active material layer, 122 . . . Negative electrode current collector, 123 . . . External terminal, 130 . . . Solid electrolyte layer, 200 . . . Exterior body, 200a . . . Opening portion, 1000 . . . All-solid-state lithium secondary battery

1. A positive electrode active material for a lithium secondary battery, comprising a lithium metal composite oxide and an Li—X compound containing Li and an element X,
wherein the Li—X compound is a lithium-ion conductive oxide,
the lithium metal composite oxide contains secondary particles, which are aggregates of primary particles,
the secondary particles have gaps among the primary particles,
the Li—X compound is present at least in the gap, the element X is one or more elements selected from the group consisting of Nb, W, and Mo, and
the positive electrode active material for the lithium secondary battery satisfies (A),
4.95≤L_{A}/Lₐᵥ (A)
(in (A), L_{A} is a crystallite diameter calculated from the highest diffraction peak within a range of 2θ=18.5±1° in a diffraction pattern of powder X-ray diffraction of the positive electrode active material for the lithium secondary battery measured using a CuKα ray, and
Lₐᵥ is an average crystallite diameter calculated from diffraction patterns included within a range of 2θ of 10° or more and 90° or less in the diffraction pattern.)

2. The positive electrode active material for the lithium secondary battery according to claim 1,
wherein DSO, a 50% cumulative volume particle diameter of the positive electrode active material for the lithium secondary battery, is 3 μm or more and 20 μm or less.

3. The positive electrode active material for the lithium secondary battery according to claim 1,
wherein a BET specific surface area of the positive electrode active material for the lithium secondary battery is 0.2 m²/g or more and 2.5 m²/g or less.

4. The positive electrode active material for the lithium secondary battery according to claim 1, represented by a composition formula (I),
Li[Liₐ(Ni_{(1-y-z-w)}Co_{y}M_{z}X_{w})₁₋ₐ]O₂ (I)
(in the composition formula (I), M is one or more elements selected from the group consisting of Mn, Fe, Cu, Ti, Mg, Al, Zn, Sn, Zr, Ga, B, Si, S, and P, X is one or more elements selected from the group consisting of Nb, W, and Mo, and the composition formula (I) satisfies −0.1≤a≤0.2, 0≤y≤0.5, 0<z≤0.7, 0<w≤0.1, and y+z+w<1.)

5. The positive electrode active material for the lithium secondary battery according to claim 1,
wherein D₁₀, D₉₀, and D₅₀ satisfy (B),
(D₉₀−D₅₀)/(D₅₀−D₁₀)≤2.0 (B)
(in (B), D₁₀ is a 10% cumulative volume particle diameter of the positive electrode active material for the lithium secondary battery, D₅₀ is a 50% cumulative volume particle diameter of the positive electrode active material for the lithium secondary battery, and D₉₀ is a 90% cumulative volume particle diameter of the positive electrode active material for the lithium secondary battery.)

6. The positive electrode active material for the lithium secondary battery according to claim 1,
wherein Lₐᵥ is 80 Å or more and 150 Å or less.

7. The positive electrode active material for the lithium secondary battery according to claim 1,
wherein Lₐ is 500 Å or more and 700 Å or less.

8. The positive electrode active material for the lithium secondary battery according to claim 3,
wherein the BET specific surface area is 1.5 m²/g or more.

9. A positive electrode for a lithium secondary battery, comprising:
the positive electrode active material for the lithium secondary battery according to claim 1.

10. A lithium secondary battery, comprising:
the positive electrode for the lithium secondary battery according to claim 9.

11. The positive electrode active material for the lithium secondary battery according to claim 2,
wherein a BET specific surface area of the positive electrode active material for the lithium secondary battery is 0.2 m²/g or more and 2.5 m²/g or less.

12. The positive electrode active material for the lithium secondary battery according to claim 2, represented by a composition formula (I),
Li[Liₐ(Ni_{(1-y-z-w)}Co_{y}M_{z}X_{w})₁₋ₐ]O₂ (I)
(in the composition formula (I), M is one or more elements selected from the group consisting of Mn, Fe, Cu, Ti, Mg, Al, Zn, Sn, Zr, Ga, B, Si, S, and P, X is one or more elements selected from the group consisting of Nb, W, and Mo, and the composition formula (I) satisfies −0.1≤a≤0.2, 0≤y≤0.5, 0<z≤0.7, 0<w≤0.1, and y+z+w<1.)

13. The positive electrode active material for the lithium secondary battery according to claim 2,
wherein D₁₀, D₉₀, and D₅₀ satisfy (B),
(D₉₀−D₅₀)/(D₅₀−D₁₀)≤2.0 (B)
(in (B), D₁₀ is a 10% cumulative volume particle diameter of the positive electrode active material for the lithium secondary battery, D₅₀ is a 50% cumulative volume particle diameter of the positive electrode active material for the lithium secondary battery, and D₉₀ is a 90% cumulative volume particle diameter of the positive electrode active material for the lithium secondary battery.)

14. The positive electrode active material for the lithium secondary battery according to claim 2,
wherein Lₐᵥ is 80 Å or more and 150 Å or less.

15. The positive electrode active material for the lithium secondary battery according to claim 2,
wherein Lₐ is 500 Å or more and 700 Å or less.

16. The positive electrode active material for the lithium secondary battery according to claim 11,
wherein the BET specific surface area is 1.5 m²/g or more.

17. A positive electrode for a lithium secondary battery, comprising:
the positive electrode active material for the lithium secondary battery according to claim 2.

18. A lithium secondary battery, comprising:
the positive electrode for the lithium secondary battery according to claim 2.
